(19) United States
(12) Patent Application Publication
(10) Pub. No.: US 2023/0238023 A1
(43) Pub. Date: Jul. 27, 2023

(54) HEAT-ASSISTED MAGNETIC RECORDING (HAMR) MEDIA WITH DUAL-LAYER MEDIA CARBON OVERCOAT

(71) Applicant: Western Digital Technologies, Inc., San Jose, CA (US)

(72) Inventors: Tan Duy Trinh, San Jose, CA (US); Yixiang Zhang, San Jose, CA (US); Sukumar Rajauria, San Jose, CA (US); Erhard Schreck, San Jose, CA (US); Qing Dai, San Jose, CA (US); Paul Christopher Dorsey, Los Altos, CA (US)

(21) Appl. No.: 18/093,596

(22) Filed: Jan. 5, 2023

Related U.S. Application Data
(60) Provisional application No. 63/303,804, filed on Jan. 27, 2022.

(51) Int. Cl. G11B 5/31; G11B 5/72

(52) U.S. Cl. CPC G11B 5/314; G11B 5/3163; G11B 5/7266; G11B 2005/0021

(57) ABSTRACT

Various apparatuses, systems, methods, and media are disclosed to provide a heat-assisted magnetic recording (HAMR) medium that has a media carbon dual-layer media carbon overcoat with both a carbon layer and a carbon-nitrogen (CN) layer. The carbon layer may be a plasma enhanced chemical vapor deposition (PECVD) carbon layer and the CN layer may be a sputtered CN layer. The dual-layer media carbon overcoat helps reduce a laser power requirement of an HAMR disk drive system and thus reduce the operating temperature of a near field transducer (NFT) of a HAMR disk drive. The dual-layer overcoat can also improve thermal and thermo-oxidative stability of the media and help retain a lubricant provided on the overcoat, therefore improving HAMR head-media interface reliability. The dual-layer media carbon overcoat can also reduce carbonaceous smear within a head-media gap.

### CROSS-REFERENCE TO RELATED APPLICATIONS

This application claims priority to and the benefit of U.S. Provisional Pa. Application No. 63/303,804, filed on Jan. 27, 2022 entitled, “HEAT-ASSISTED MAGNETIC RECORDING (HAMR) MEDIA WITH DUAL-LAYER MEDIA CARBON OVERCOAT,” the entire content of which is incorporated herein by reference.

### FIELD

The disclosure relates, in some aspects, to magnetic recording media. More specifically, but not exclusively, the disclosure relates to a magnetic recording media with a media carbon overcoat for use with heat-assisted magnetic recording (HAMR).

### INTRODUCTION

Magnetic storage systems, such as a hard disk drive (HDD), are utilized in a wide variety of devices in stationary and mobile computing environments. Examples of devices that incorporate magnetic storage systems include desktop computers, portable notebook computers, portable hard disk drives, high-definition television (HDTV) receivers, television set top boxes, video game consoles, and portable media players.

A typical disk drive includes magnetic storage media in the form of one or more flat disks. The disks are generally formed of few main substances, namely, a substrate material that gives it structure and rigidity, a magnetic recording layer that holds the magnetic impulses or moments that store digital data, and media overcoat and lubricant layers to protect the magnetic recording layer. The typical disk drive also includes a read head and a write head, generally in the form of a magnetic transducer which can sense and/or change the magnetic fields stored on the recording layer of the disks.

Energy/Heat Assisted Magnetic Recording (EAMR/HAMR) systems can increase the areal density of information recorded magnetically on various magnetic media. To achieve higher areal density for magnetic storage, smaller magnetic grain size (e.g., less than 6 nm) media may be required. In HAMR, high temperatures are applied to the media during writing to facilitate recording to small grains. The high temperatures may be achieved using a near field transducer (NFT) that is coupled to a laser diode of a slider of a HAMR disk drive. However, the use of high temperatures during writing onto the HAMR media can present operational challenges and cause undesirable effects such as reliability issues in the HAMR components, including the media and head/slider, or cause a formation of carbonaceous smear on the NFT or in the head-media gap.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one embodiment, a magnetic recording medium includes: a substrate; a magnetic recording layer on the substrate; a capping layer on the magnetic recording layer; and a dual-layer media carbon overcoat on the capping layer, the dual-layer media carbon overcoat comprising a carbon layer and a carbon-nitrogen (CN) layer, wherein the carbon layer is less rough than the CN layer. In some aspects, the carbon layer is on the capping layer and the CN layer is on the carbon layer. In other aspects, the CN layer is on the capping layer and the carbon layer is on the CN layer. In some aspects, the carbon layer is a plasma enhanced chemical vapor deposition (PECVD) carbon layer and the CN layer is a sputtered carbon-nitrogen (CN) layer. In some aspects, the magnetic recording layer is on a heat sink layer and a lubricant layer is on the dual-layer media carbon overcoat.

In some examples, the dual-layer media carbon overcoat helps to reduce a laser power requirement of an HAMR disk drive system and thus reduce the temperature of a near field transducer (NFT) of a HAMR disk drive. The dual-layer media carbon overcoat can also improve thermal and thermo-oxidative stability of the media and help retain a lubricant that is provided on the dual-layer media carbon overcoat, therefore improving HAMR head-media interface reliability. The dual-layer media carbon overcoat can also reduce carbonaceous smear on the NFT or in the head-media gap.

In another embodiment, a method for manufacturing an HAMR medium is disclosed. The method includes: providing a substrate; providing a magnetic recording layer on the substrate; and depositing a dual-layer media carbon overcoat on the magnetic recording layer, the dual-layer media carbon overcoat comprising a PECVD carbon layer and a sputtered CN layer, wherein the PECVD carbon layer is less rough than the sputtered CN layer. In some aspects, the PECVD carbon layer is provided on the capping layer and the CN layer is provided on the PECVD carbon layer. In other aspects, the CN layer is provided on the capping layer and the PECVD carbon layer is provided on the CN layer. In some aspects, the method further comprises providing other layers within the HAMR medium, such as a lubricant layer on the dual-layer media carbon overcoat and various layers between a substrate of the HAMR medium and the magnetic recording layer of the HAMR medium, such as a heat sink layer and a seed layer.

In yet another embodiment, a medium configured for HAMR includes: a substrate; a magnetic recording layer on the substrate; and a dual-layer media carbon overcoat on the magnetic recording layer, the dual-layer media carbon overcoat comprising a PECVD carbon layer and a CN layer, wherein the PECVD carbon layer is less rough than the sputtered CN layer. In some aspects, the PECVD carbon layer is on the capping layer and the CN layer is on the PECVD carbon layer. In other aspects, the CN layer is on the capping layer and the PECVD carbon layer is on the CN layer. In some aspects, the sputtered CN layer has a percentage (by weight) of N within the CN between 5% and 30%, inclusive. In some aspects, the HAMR medium includes other layers, such as a lubricant layer on the dual-layer media carbon overcoat and various layers between a substrate of the HAMR medium and the magnetic recording layer of the HAMR medium, such as a heat sink layer and a seed layer.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 is a top schematic view of an exemplary disk drive configured for heat-assisted magnetic recording (HAMR) including a slider and a HAMR medium having an overcoat that includes both a plasma enhanced chemical vapor deposition (PECVD) carbon layer and a sputtered carbon-nitrogen (CN) layer in accordance with an aspect of the disclosure.

FIG. 2 is a side schematic view of the exemplary slider and HAMR medium of FIG. 1 in accordance with an aspect of the disclosure.

FIG. 3 is a side schematic view of an exemplary HAMR medium with an overcoat that includes both a PECVD carbon layer and a sputtered CN layer in accordance with an aspect of the disclosure.

FIG. 4 is a side schematic view of another exemplary HAMR medium with an overcoat that includes both a carbon layer and a CN layer in accordance with an aspect of the disclosure.

FIG. 5 is a side schematic view of another exemplary HAMR medium with an overcoat that includes both a carbon layer and a CN layer in accordance with an aspect of the disclosure.

FIG. 6 is a side schematic view of another exemplary HAMR medium with an overcoat that includes both a PECVD carbon layer and a sputtered CN layer in accordance with an aspect of the disclosure.

FIG. 7 is a flowchart of an exemplary process for fabricating a HAMR medium that includes both a PECVD carbon layer and a sputtered CN layer in accordance with some aspects of the disclosure.

FIG. 8 is a side schematic view of another exemplary HAMR medium with an overcoat that includes both a PECVD carbon layer and a sputtered CN layer in accordance with an aspect of the disclosure.

FIG. 9 is a side schematic view of another exemplary HAMR medium with an overcoat that includes both a carbon layer and a CN layer in accordance with an aspect of the disclosure.

FIG. 10 is a flowchart of another exemplary process for fabricating a HAMR medium that includes both a PECVD carbon layer and a sputtered CN layer in accordance with some aspects of the disclosure.

FIG. 11 is a flowchart of an exemplary process for fabricating a HAMR medium that includes both a carbon layer and a CN layer in accordance with some aspects of the disclosure.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to various apparatuses, systems, methods, and media for providing heat-assisted magnetic recording (HAMR) media that can, among other features, improve the reliability of a near field transducer (NFT) used in a slider of a HAMR disk drive. In a HAMR disk drive, a laser source and an optical waveguide with a NFT (typically implemented on or in a slider) are used to generate localized heating in the media while a writing element or writer writes data to the media.

HAMR systems may suffer from reliability issues arising due to, for example, the high temperatures required to achieve HAMR, such as an NFT temperature of 200° C. or more. The high temperatures can result in a formation of carbonaceous smear at the head-media gap, causing NFT deformation and an increase in the flying height of the slider. These issues can, in turn, lead to (a) a higher failure rate than is otherwise acceptable and/or (b) a shorter mean time to failure (MTTF). It would be desirable to provide a HAMR media that can operate effectively using less laser power to reduce NFT and head temperatures, and also reduce carbonaceous smearing.

Herein, to address these and other issues, a dual-layer media carbon overcoat is provided that includes both a plasma-enhanced chemical vapor deposition (PECVD) carbon layer and a sputtered carbon-nitrogen (CN) layer. The dual-layer media carbon overcoat helps to reduce the laser power requirement and thus can reduce NFT and head temperature. The dual-layer media carbon overcoat can also improve thermal stability of the media carbon layers and help retain a lubricant layer, therefore improving HAMR head-media interface reliability. The dual-layer media carbon overcoat can also reduce carbonaceous smear on the NFT during writing. In particular, the CN layer has a sealing effect that inhibits carbon emissions from underlying layers (e.g., in the media) that can lead to carbonaceous smearing on the NFT and in the media-head gap.

Note that CN has not been commonly used as a carbon overcoat in HAMR media in the past because CN is rather porous and often does not provide adequate corrosion resistance. Moreover, CN tends to be rough, thus causing possible problems in the smoothness of other layers, as well as thermal gradient issues. However, by providing the PECVD carbon layer along with the CN layer, the PECVD tends to smooth out the other media layers (e.g., adjacent media layers such as the CN layer), thus mitigating the downsides of CN, while still allowing the benefits of the CN layer, such as its sealing effect and reduction of carbonaceous smearing. That is, the PECVD layer is less rough (and also less porous) than the CN layer and hence helps to allow for media layers, and the overall media layer structure, that are smoother (e.g., less rough).

Herein, a PECVD carbon layer is a film, layer, material or structure that is formed of carbon that is deposited using PECVD and therefore has a configuration or structure associated with PECVD. A PECVD carbon layer may also be regarded as a carbon layer that is configured in accordance with PECVD. The PECVD carbon layer is substantially free of nitrogen (other than trace amounts) and is thus distinct from a CN layer. For example, the PECVD carbon layer has less than 1% N by atomic weight as a trace amount within its carbon. In some examples, a threshold value may be specified for the maximum amount of trace N within the PECVD carbon layer, with the PECVD carbon layer formed so as to have an amount of N below that threshold. The configuration or structure of a PECVD carbon layer differs at least somewhat from the configuration or structure of a carbon layer formed using a different deposition technique, at least at a microscopic or sub-microscopic level. For example, a PECVD carbon layer may have a different roughness (or smoothness), porosity (or void fraction), density, and/or hardness than a carbon layer deposited using a different process.

In some examples: the PECVD carbon layer has a center line average roughness or arithmetic average roughness (RA) in the range of 1 angstroms (Å) to 4 Å, with a typical roughness of 2.5 Å; the PECVD layer has a density in the range of 1500 kg/m³ to 2100 kg/m³, with a typical density of 1800 kg/m³; and the PECVD layer has a hardness in the range of 14 (gigapascals) GPa to 19 GPa, with a typical hardness of 16.5 GPa. Other parameters may be used for quantifying roughness or smoothness, such as maximum valley depth below a mean line or maximum peak height above a mean line as well as root mean square roughness. Other parameters may be used for quantifying harness, such as the Brinell, Rockwell or Vickers scales. Various parameters may be used for quantifying porosity, such as statistical distribution of pore size (e.g., an average value or “effective pore”), and surface density of the pores (i.e., the number of pores per unit area). In some examples, PECVD threshold values may be specified for each of these different parameters (roughness, density, hardness, and porosity) with the PECVD carbon layer formed so that its parameters satisfy one or more of the PECVD thresholds. By way of example, a PECVD roughness threshold may be defined (e.g., 4 Å) with the PECVD carbon layer formed to have a roughness (e.g., 2.5 Å) below that threshold (or a smoothness greater than the threshold).

Herein, a sputtered CN layer is a film, layer, material or structure that is formed of C and N that is deposited using sputtering and therefore has a configuration or structure associated with sputtering or sputter deposition. A sputtered CN layer may also be regarded as a CN layer configured in accordance with sputtering or sputter deposition. The configuration or structure of the sputtered CN layer differs at least somewhat from the configuration or structure of a CN layer formed using a different deposition technique, at least at a microscopic or sub-microscopic level. For example, a sputtered CN layer may have a different density or hardness than a CN layer deposited using a different process.

In some examples: the sputtered CN layer has a center line average roughness or arithmetic average roughness (RA) in the range of 2 Å to 6 Å, with a typical roughness of 4 Å; the sputtered CN layer has a density in the range of 1500 kg/m³ to 2100 kg/m³, with a typical density of 1800 kg/m³; and the sputtered CN layer has a hardness in the range of 9 GPa to 13 GPa, with a typical hardness of 11 GPa. Other parameters again may be used for quantifying roughness or smoothness, harness, and porosity). Note that the typical or average roughness of the PECVD carbon layer (2.5 Å) is less than the typical or average roughness of the sputtered CN layer (4 Å). The typical or average porosity of the PECVD carbon layer is also less than the typical or average porosity of the sputtered CN layer. As already noted, the PECVD carbon layer thus helps to improve the smoothness of the media layers, which might otherwise be too rough due to the presence of the sputtered CN layer, while also improving corrosive resistance. In some examples, sputtered CN threshold values may be specified for each of these different parameters (roughness, density, hardness, and porosity) with the sputtered CN layer formed so that its parameters satisfy one or more of the sputtered CN thresholds. By way of example, a sputtered CN roughness threshold may be defined (e.g., 6 Å) with the sputtered CN carbon layer formed to have a roughness (e.g.. 6 Å) below that threshold (or a smoothness greater than the threshold). Still further, thresholds may be defined to distinguish between the parameters of the PECVD carbon layer and the sputtered CN layer. For example, a roughness threshold of 3 Å may be defined with the PECVD carbon layer formed to have an average roughness less than the threshold (e.g., 2.5 Å) and with the sputtered CN layer formed to have an average roughness at or above the threshold (e.g., 4 Å). It is noted that other parameters may be used to quantify various optical and electrical properties of the different carbon layers, e.g., n (refractive index), k (extinction coefficient), and p (electrical conductivity). In some examples, PECVD carbon has n = 2.1, k = 0.04. and p (in ohm.m) of 2.7 × 10⁴; whereas sputtered carbon has n = 2.3, k = 0.50, and p (in ohm.m) of 1.1 × 10⁻¹.

In other aspects, a dual-layer media carbon overcoat is provided that includes a dual-layer carbon overcoat with a carbon layer and a CN layer, with the CN layer on the carbon layer, the carbon layer on a capping layer, such as a CoFe capping layer, and with the capping layer on an MRL. That is, in some aspects, the carbon layer need not necessarily be a PECVD carbon layer but may be formed using a different process and the CN layer need not necessarily be a sputtered CN layer but may instead be formed using a different process.

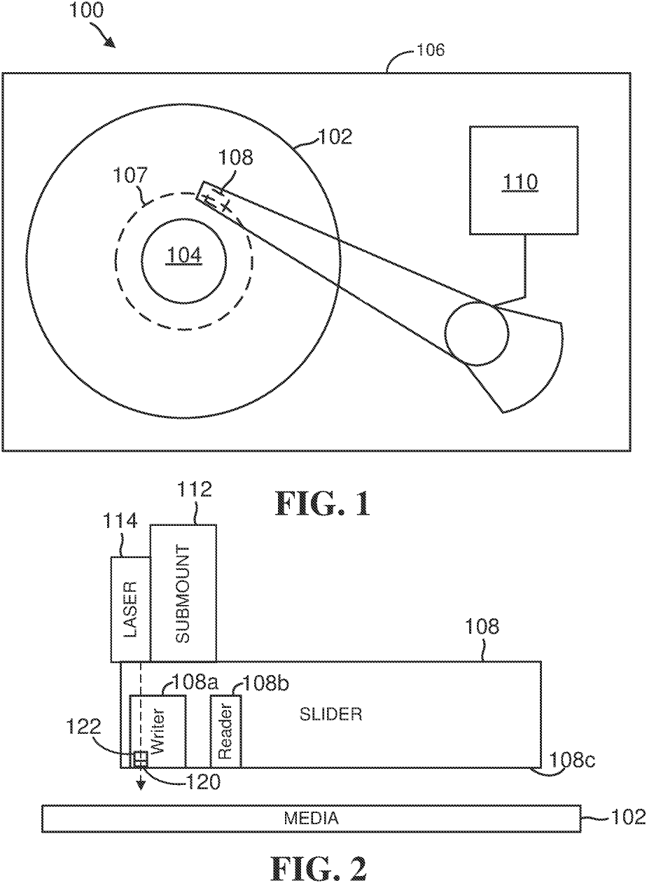

FIG. 1 is a top schematic view of a data storage device 100 (e.g., disk drive or magnetic recording device) configured for magnetic recording and comprising a slider 108 and a magnetic recording medium 102 that includes a dual-layer carbon overcoat with, for example, a PECVD carbon layer and a sputtered CN layer. In illustrative examples, the magnetic recording medium 102 includes an energy/heat assisted magnetic recording (EAMR/HAMR) medium. The laser (not visible in FIG. 1 but see 114 in FIG. 2) is positioned with a head/slider 108. Disk drive 100 may comprise one or more disks/media 102 to store data. Disk/media 102 resides on a spindle assembly 104 that is mounted to a drive housing 106. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR) based elements, such as tunnel magneto-resistive (TMR) elements for reading, and a write pole with coils that can be energized for writing. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an exemplary HAMR system is shown, at least some aspects of the disclosure may be used in other EAMR or in non-EAMR magnetic data recording systems, including shingle-written magnetic recording (SMR) media, perpendicular magnetic recording (PMR) media, or microwave assisted magnetic recording (MAMR) media.

FIG. 2 is a side schematic view of the slider 108 and magnetic recording medium 102 of FIG. 1. The magnetic recording medium 102 may include a dual-layer carbon overcoat with, for example, a PECVD carbon layer and a sputtered CN layer. The slider 108 may comprise a sub-mount 112 attached to a top surface of the slider 108. The laser 114 may be attached to the sub-mount 112, and possibly to the slider 108. The slider 108 comprises a write element (e.g., writer) 108a and a read element (e.g., reader) 108b positioned along an air bearing surface (ABS) 108c of the slider for writing information to, and reading information from, respectively, the media 102. In other aspects, the slider may also comprise a layer of Si or Si cladding 120. This layer is optional.

In operation, the laser 114 is configured to generate and direct light energy to a waveguide (e.g., along the dashed line) in the slider which directs the light to an NFT 122 near the air bearing surface (e.g., bottom surface) 108c of the slider 108. Upon receiving the light from the laser 114 via the waveguide, the NFT 122 generates localized heat energy that heats a portion of the media 102 within or near the write element 108a, and near the read element 108b. The anticipated recording temperature is in the range of about 350° C. to 400° C. In the aspect illustrated in FIG. 2, the laser directed light is disposed within the writer 108a and near a trailing edge of the slider. In other aspects, the laser directed light may instead be positioned between the writer 108a and the reader 108b. FIGS. 1 and 2 illustrate a specific example of a HAMR system. In other examples, the magnetic recording medium 102 can be used in other suitable HAMR systems (e.g., with other sliders configured for HAMR).

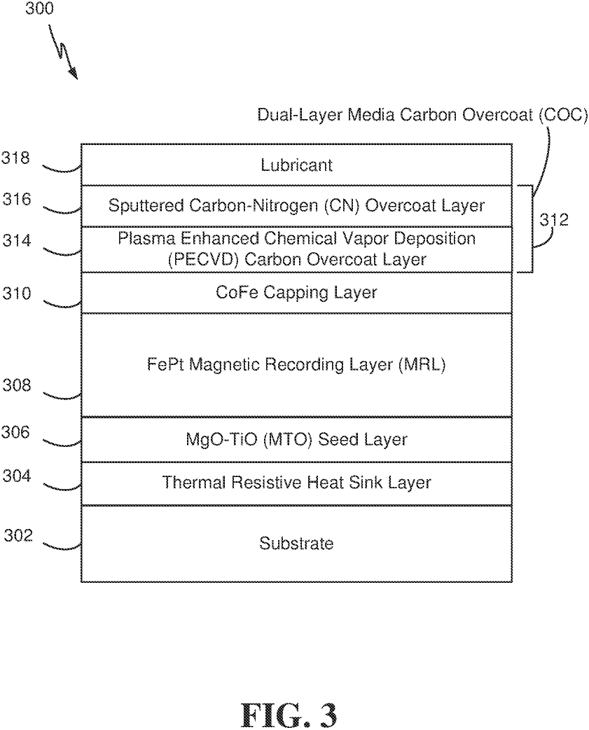

FIG. 3 is a side schematic view of an exemplary HAMR medium 300 in accordance with an aspect of the disclosure. The HAMR medium 300 has a stacked structure with a substrate 302 at a bottom/base layer, a thermal resistive heat sink layer 304 on the substrate 302, an MgO-TiO (MTO) seed layer 306 on the heat sink layer 304, an FePt magnetic recording layer (MRL) 308 on the seed layer 306, a CoFe capping layer 310 on the MRL 308, a dual-layer media carbon overcoat (COC) 312 on the capping layer 310, and a lubricant layer 318 on the COC 312. The dual-layer COC 312 includes, in this example, a PECVD carbon overcoat layer 314 on the CoFe capping layer 310 and a sputtered CN overcoat layer 316 is on the PECVD carbon overcoat layer 314 (with the lubricant layer 318 on the CN overcoat layer 316). In other examples, the sputtered CN overcoat layer 316 is on the CoFe capping layer 310 and the PECVD carbon overcoat layer 314 is on the sputtered CN overcoat layer 316.

The terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

In some examples, the MRL 310 includes one or more magnetic recording layers for storing data magnetically, not explicitly shown in in FIG. 3. For example, the MRL 310 may include magnetic recording sub-layers and exchange control sub-layers (ECLs). Collectively, the sub-layers form an MRL structure 310 that may be, e.g., 100 - 200 angstroms (Å) thick.

In some examples, the substrate 302 has a diameter (i.e., OD) of about 97 mm and a thickness of about 0.5 mm. In other examples, the OD may be 95 mm or 95.1 mm. (Generally speaking, such disks are all referred to as “3.5 inch” disks.)

In some aspects, the substrate 302 may be made of one or more materials such as an Al alloy, NiP plated Al, glass, glass ceramic, and/or combinations thereof. In some aspects, the heat sink layer 304 can be made of one or more materials such as Ag, Al, Au, Cu, Cr, Mo, Ru, W, CuZr, MoCu, AgPd, CrRu. CrV, CrW. CrMo, CrNd, NiAl, NiTa, combinations thereof, and/or other suitable materials known in the art. In some aspects, the seed layer 306 may be made of MgO without the TiO or made with other suitable materials known in the art.

In some aspects, the FcPt MRL 308 may be made instead of an alloy selected from FePtX, where X is a material selected from Cu, Ni, and combinations thereof. In other aspects, the MRL 308 may be made instead of a CoPt alloy. In some aspects, the CoFe capping layer 310 may be made instead of just Co. Pt, or Pd. In one example, the capping layer 310 can be a bi-layer structure having a top layer including Co and a bottom layer including Pt or Pd. In addition to the Co/Pt and Co/Pd combinations of the top layer and the bottom layer, specific combinations of the top layer materials and the bottom layer materials may include, for example, Co/Au, Co/Ag, Co/Al, Co/Cu, Co/lr, Co/Mo, Co/Ni, Co/Os, Co/Ru, Co/Ti, Co/V, Fe/Ag, Fe/Au, Fe/Cu, Fe/Mo, Fe/Pd. Ni/Au, Ni/Cu, Ni/Mo, Ni/Pd, Ni/Re, etc. In additional examples, top layer materials and bottom layer materials include any combination of Pt and Pd (e.g., alloys), or any of the following elements, alone or in combination: Au, Ag, Al, Cu, Ir, Mo, Ni, Os, Ru, Ti, V, Fe, Re, and the like. In some aspects, the lubricant layer 318 is made of a polymer-based lubricant. The lubricant layer 318 may be, for example, between 4 Å and 10 Å, inclusive and, more particularly, between 6 Å and 7 Å, inclusive. Note that, although not shown in FIG. 3, the HAMR media 300 may also include an adhesive layer and a soft underlayer (SUL) formed (in that order) between the substrate 302 and the heat sink layer 304.

As noted, the COC 312 is a dual-layer structure that includes both the PECVD carbon overcoat layer 314 and the sputtered CN overcoat layer 316. The PECVD carbon overcoat layer 314 is provided to, e.g., protect the media 300 from corrosion and to maintain surface smoothness of a top surface of the media 300. The sputtered CN overcoat layer 316 is used to, e.g., provide thermal stability and improve lubricant retention. The sputtered CN overcoat layer 316 also helps to reduce a laser power requirement (i.e., reducing the amount of power required by the laser during HAMR writing in comparison with the amount of laser power required without a CN overcoat layer), thus achieving head temperature reduction. Generally speaking, it is preferred that the overcoat layers be made as thin as possible while still being sufficiently thick to adequately perform their overcoat functions. The CN layer may require a minimum thickness to establish and maintain its functionality (e.g., to prevent carbon emissions that cause smearing). The thickness of the PECVD may depend on the thickness of its underlying layer.

In some aspects, the thickness of the sputtered CN overcoat layer 316 may be, e.g., between 3 Å and 30 Å, inclusive and, more particularly, between 6 Å and 20 Å, inclusive. In some particular examples, the sputtered CN overcoat layer 316 is either 5 Å or 10 Å thick. The thickness of the PECVD carbon overcoat layer 314 may be, e.g., between 10 Å and 40 Å, inclusive, and, more particularly, between 20 Å and 30 Å, inclusive. Note that the ideal thickness of the PECVD carbon overcoat layer 314 may depend on the roughness of the underlying capping layer 310. For example, if the capping layer 310 is relatively rough, the PECVD carbon overcoat layer 314 may be made relatively thick (e.g., closer to 40 Å) to more effectively smooth out that roughness. On the other hand, if the capping layer 310 is relatively smooth, the PECVD carbon overcoat layer 314 may be made relatively thinner (e.g., closer to 10 Å). In some examples, the overall thickness of the dual-layer COC is between 20 Å and 50 Å. Note that, although a dual-layer COC may be thicker than a single-layer COC, areal density is not significantly degraded due to the added thickness so long as the head to media spacing is not significantly increased. Note also that a thickness ratio (or a difference in thickness) between the two types of media carbon in the dual-layer COC may be adjusted for laser power optimization, media surface smoothness, media surface corrosion protection and head-media interface robustness. For example, for a particular thickness of the sputtered CN layer, the thickness of the PECVD layer may be increased or decreased to achieve a desired media surface smoothness.

In some examples, the sputtered CN overcoat layer 316 is formed to have a percentage (by atomic weight) of N within the CN of, e.g., between 5% and 30%, inclusive, and hence the percentage (by atomic weight) of C within the CN may be, e.g., between 70% and 95%, inclusive. Note that the PECVD layer 314 and the CN overcoat layer 316 may both also include some amount of hydrogen and oxygen.

Otherwise routine experimentation can be used to determine suitable or preferred overcoat layer thicknesses and/or CN component percentages within the above-listed ranges of values for use within practical HAMR systems based on the particular characteristics of the system, such as its operating temperature, the desired areal density of data, etc.

HAMR systems configured in accordance with the foregoing teachings have been found, in some examples, to (a) improve MTTF, (b) reduce failure rates, and (c) mitigate flying height increase (ΔFH). The amount of reduction in laser power may depend on the thickness of the sputtered CN overcoat layer. HAMR systems configured in accordance with the foregoing teachings have been found, in some examples, to: (a) reduce the laser power requirement; (b) reduce carbonaceous smear formation at the head-media gap; and (c) reduce lubricant loss, as compared to similar HAMR media with only a PECVD overcoat layer but no sputtered CN overcoat layer. Laser power reduction is substantially consistent for same head-media spacing or same clearance.

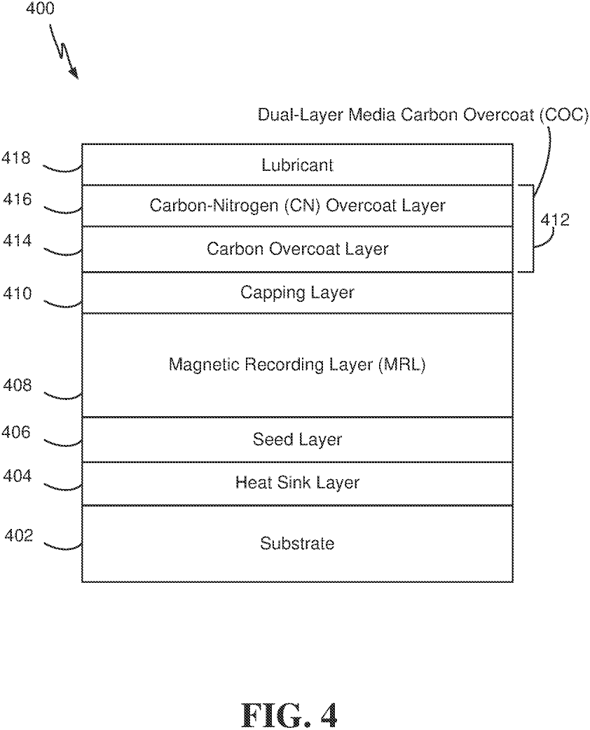

FIG. 4 is a side schematic view of an exemplary HAMR medium 400 in accordance with another aspect of the disclosure. The HAMR medium 400 has a stacked structure with a substrate 402 at a bottom/base layer, a heat sink layer 404 on the substrate 402, a seed layer 406 on the heat sink layer 404, an MRL 408 on the seed layer 406. a capping layer 410 on the MRL 408, a dual-layer COC 412 on the capping layer 412, and a lubricant layer 418 on the dual-layer COC 412. The dual-layer COC 412 includes a carbon overcoat layer 414 on the capping layer 410 and a CN overcoat layer 416 on the carbon layer 414 (with the lubricant layer 418 on the CN layer 416, as shown). In some examples, the CN overcoat layer 416 has a percentage (by atomic weight) of N within the CN overcoat layer 416 of, e.g., between 5% and 30%, inclusive, and hence the percentage (by weight) of carbon within the CN overcoat layer 416 may be, e.g., between 70% and 95%, inclusive. In other examples, the sputtered CN overcoat layer 416 is on the CoFe capping layer 410 and the carbon overcoat layer 414 is on the sputtered CN overcoat layer 416. In some examples, the MRL 410 may include one or more magnetic recording layers, which are not explicitly shown in in FIG. 4. Layers 402-410 and 418 may be made of the materials described above for the corresponding layers of the HAMR medium 300 of FIG. 3 or other suitable materials known in the art.

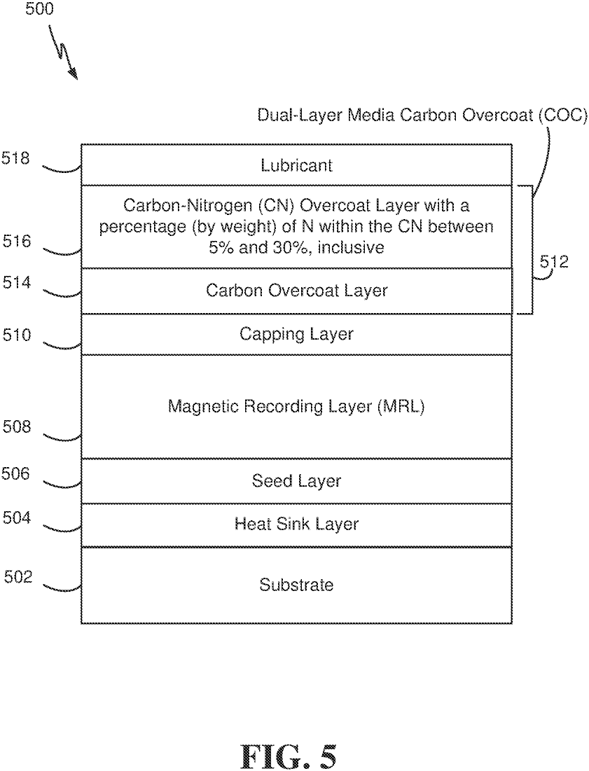

FIG. 5 is a side schematic view of an exemplary HAMR medium 500 in accordance with another aspect of the disclosure. The HAMR medium 500 has a stacked structure with a substrate 502 at a bottom/base layer, a heat sink layer 504 on the substrate 502, a seed layer 506 on the heat sink layer 504. an MRL 508 on the seed layer 506, a capping layer 510 on the MRL 508, a dual-layer COC 512 on the capping layer 512, and a lubricant layer 518 on the dual-layer COC 512. The dual-layer COC 512 includes a carbon overcoat layer 514 on the capping layer 510 and a CN overcoat layer 516 on the carbon overcoat layer 514 (with the lubricant layer 518 on the CN layer 516, as shown). In some examples, the CN overcoat layer 516 has a percentage (by weight) of N within the CN of between 5% and 30%, inclusive. In other examples, the CN overcoat layer 516 is on the capping layer 510 and the carbon overcoat layer 514 is on the CN overcoat layer 516. In some examples, the MRL 510 may include one or more magnetic recording layers, which are not explicitly shown in in FIG. 5. Layers 502-510 and 518 may be made of the materials described above for the corresponding layers of the HAMR medium 300 of FIG. 3 or other suitable materials known in the art

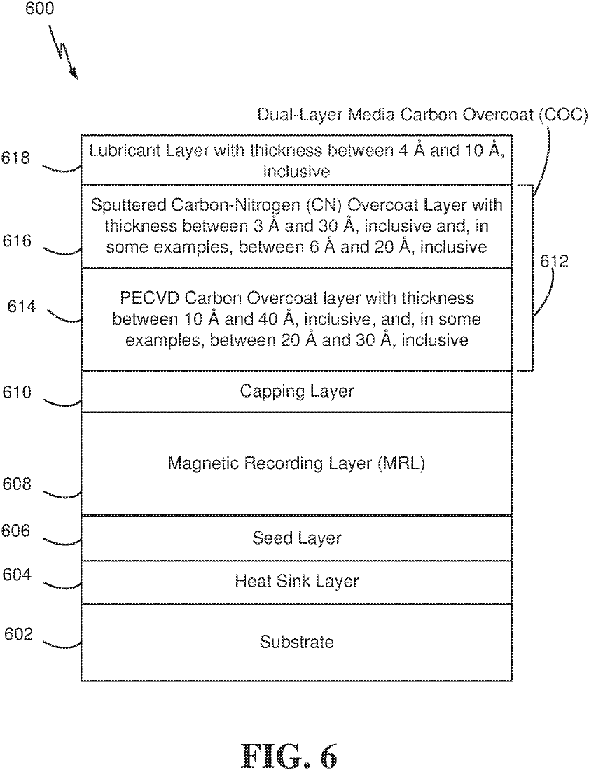

FIG. 6 is a side schematic view of an exemplary HAMR medium 600 in accordance with another aspect of the disclosure. The HAMR medium 600 has a stacked structure with a substrate 602 at a bottom/base layer, a heat sink layer 604 on the substrate 602, a seed layer 606 on the heat sink layer 604. an MRL 608 on the seed layer 606, a capping layer 610 on the MRL 608, a dual-layer COC 612 on the capping layer 612, and a lubricant layer 618 on the dual-layer COC 612. The dual-layer COC 612 includes a PECVD carbon overcoat layer 614 on the capping layer 610 and a sputtered CN overcoat layer 616 on the carbon overcoat layer 614 (with the lubricant layer 618 on the sputtered CN layer 614, as shown). In some examples, the PECVD carbon overcoat layer 614 has a thickness between 10 Å and 40 Å, inclusive, and, in some examples, between 20 Å and 30 Å, inclusive. In some examples, the CN overcoat layer 616 has a thickness between 3 Å and 30 Å, inclusive and, in some examples, between 6 Å and 20 Å, inclusive. In other examples, the sputtered CN overcoat layer 616 is on the capping layer 610 and the PECVD carbon overcoat layer 614 is on the CN overcoat layer 616. In some examples, the lubricant layer 618 has a thickness between 4 Å and 10 Å, inclusive. In some examples, the MRL 610 includes one or more magnetic recording layers, which are not explicitly shown in in FIG. 6. Layers 602-610 and 618 may be made of the materials described above for the corresponding layers of the HAMR medium 300 of FIG. 3 or other suitable materials known in the art

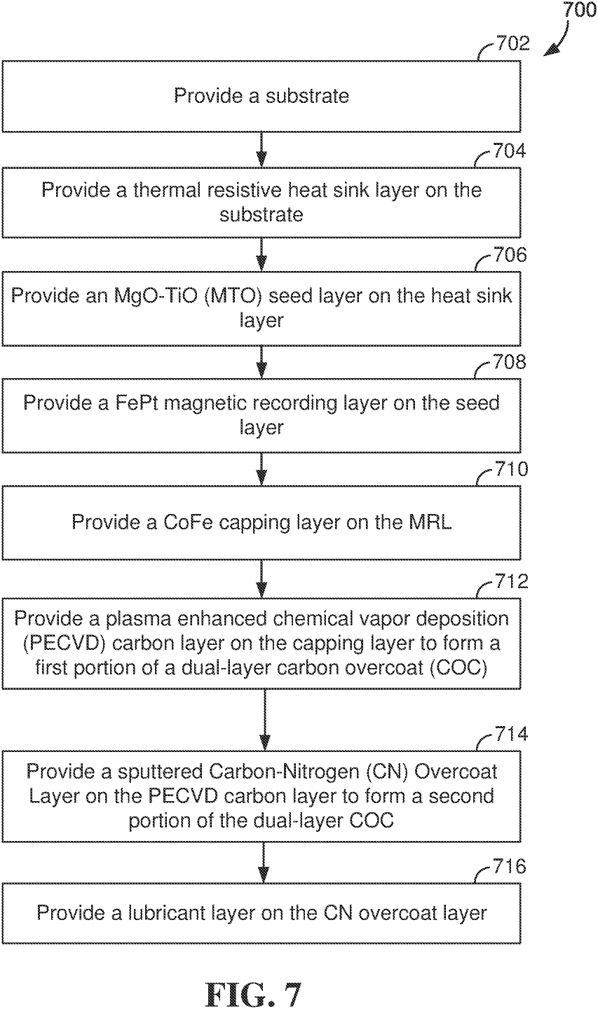

FIG. 7 is a flowchart of a process 700 for fabricating a HAMR medium with a dual-layer COC in accordance with some aspects of the disclosure. In one aspect, the process 700 can be used or modified to fabricate any of the HAMR media described above in relation to FIGS. 3-6. In block 702, the process provides a substrate. In some aspects, the substrate can be made of one or more materials such as an Al alloy, NiP plated Al, glass, glass ceramic, and/or combinations thereof. In block 704, the process provides a thermal resistive heat sink layer. In some aspects, the heat sink layer 704 can be made of one or more materials such as Ag, Al, Au, Cu, Cr, Mo, Ru, W, CuZr, MoCu, AgPd, CrRu, CrV, CrW, CrMo, CrNd, NiAl, NiTa, combinations thereof, and/or other suitable materials known in the art.

In block 706, the process provides an MgO-TiO (MTO) seed layer on the heat sink layer (e.g., an MTO seed layer may be deposited on the heat sink layer). In some aspects, the seed layer 306 may be made of MgO without the TiO or made with other suitable materials known in the art. In block 708, the process provides a FePt MRL on the seed layer (e.g., an FePt MRL may be deposited on the MTO seed layer). In one example, the MRL may include one or more magnetic recording layers for storing data magnetically. For example, the MRL may include magnetic recording sub-layers and ECLs. In some aspects, the FePt MRL may be made instead of an alloy selected from FePtX, where X is a material selected from Cu, Ni, and combinations thereof. In other aspects, the MRL may be made instead of a CoPt alloy.

In block 710, the process provides a CoFe capping layer on the MRL (e.g., a CoFe capping layer may be deposited on the FePt MRL). In some aspects, the CoFe capping layer may be made instead of Co. Pt, or Pd. In one example, the capping layer can be a bi-layer structure having a top layer including Co and a bottom layer including Pt or Pd. In addition to the Co/Pt and Co/Pd combinations of the top layer and the bottom layer, specific combinations of the top layer materials and the bottom layer materials may include, for example, Co/Au, Co/Ag, Co/Al, Co/Cu, Co/Ir, Co/Mo, Co/Ni, Co/Os, Co/Ru, Co/Ti, Co/V, Fe/Ag, Fe/Au, Fe/Cu, Fe/Mo, Fe/Pd, Ni/Au, Ni/Cu, Ni/Mo, Ni/Pd, Ni/Rc, etc. In additional examples, top layer materials and bottom layer materials include any combination of Pt and Pd (e.g., alloys), or any of the following elements, alone or in combination: Au, Ag, Al. Cu, Ir. Mo, Ni, Os, Ru, Ti, V, Fe, Re, and the like.

In block 712, the process provides a PECVD carbon overcoat layer on the capping layer to form a first (lower or bottom) portion of a dual-layer COC (e.g., carbon is deposited via PECVD on the capping layer). Although PECVD is preferred, in other examples, the carbon overcoat layer might be provided using a variety of other deposition processes or sub-processes, including, but not limited to physical vapor deposition (PVD), sputter deposition and ion beam deposition, and other forms of chemical vapor deposition (CVD) besides PECVD. low pressure chemical vapor deposition (LPCVD) and atomic layer chemical vapor deposition (ALCVD). In other aspects, other suitable deposition techniques known in the art might also be used. In some examples, the thickness of the PECVD carbon overcoat layer may be, e.g., between 10 Å and 40 Å, inclusive, and, more particularly, between 20 Å and 30 Å, inclusive.

In block 714, the process provides a sputtered CN overcoat layer on the PECVD carbon overcoat layer to form a second (upper or top) portion of the dual-layer COC (e.g., CN is deposited via sputtering on the PECVD carbon overcoat layer). Although sputtering is preferred, in other examples, the CN overcoat layer might be provided using a variety of other deposition processes or sub-processes, including, but not limited to PVD, ion beam deposition, and CVD including PECVD, LPCVD and ALCVD. In other aspects, other suitable deposition techniques known in the art might also be used. In some examples, the sputtered CN overcoat layer is provided to have a percentage (by weight) of N within the CN overcoat layer of, e.g., between 5% and 30%, inclusive, and hence the percentage (by weight) of C within the CN overcoat layer may be, e.g., between 70% and 95%, inclusive. In some aspects, the thickness of the sputtered CN overcoat layer may be, e.g., between 3 Å and 30 Å, inclusive and, more particularly, between 6 Å and 20 Å, inclusive. In some particular examples, the sputtered CN overcoat layer is either 5 Å or 10 Å thick. In other examples, blocks 712 and 714 are reversed in order. That is, the CN layer is provided on the capping layer and then the PECVD carbon layer is provided on the CN layer.

In block 716, the process provides a lubricant layer on the sputtered CN overcoat layer (e.g., a lubricant may be deposited on or applied to the CN overcoat layer). In some aspects, the lubricant layer is made of a polymer-based lubricant. The lubricant layer may be, for example, between 4 Å and 10 Å, inclusive and, more particularly, between 6 Å and 7 Å, inclusive. Note that, although not shown in FIG. 7, the processes for manufacturing the HAMR media may also provide an adhesive layer and a soft underlayer (SUL) formed (in that order) between the substrate and the heat sink layer.

Insofar as the processes described herein are concerned, the processes can in some cases perform the sequence of actions in a different order. In another aspect, the process can skip one or more of the actions. In other aspects, one or more of the actions are performed simultaneously. In some aspects, additional actions can be performed. As noted, the deposition of at least some of the layers can be performed using any of a variety of deposition processes or sub-processes, including, but not limited to PVD. sputter deposition and ion beam deposition, CVD including PECVD, LPCVD and ALCVD. In other aspects, other suitable deposition techniques known in the art may also be used.

### Alternative and Additional Examples

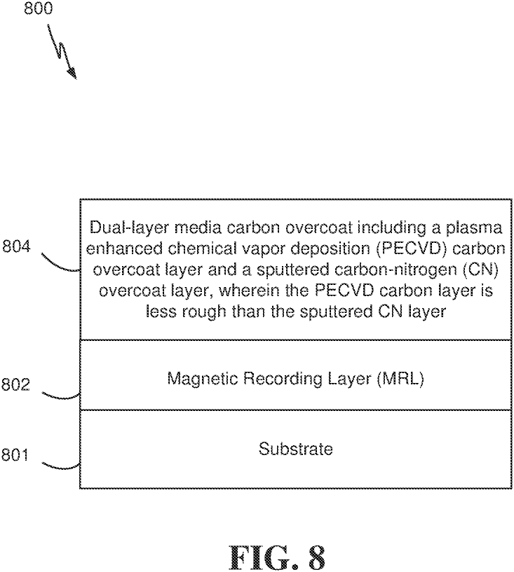

FIG. 8 is a side schematic view of an exemplary HAMR medium 800 in accordance with another aspect of the disclosure. The HAMR medium 800 has a stacked structure with a substrate 801, an MRL 802 on the substrate 801, and a dual-layer media carbon overcoat 804 on the MRL 804, where the dual-layer media carbon overcoat 804 includes a PECVD carbon overcoat layer and a sputtered CN overcoat layer, and wherein the PECVD carbon layer is less rough (at least on the average) than the sputtered CN layer. In some aspects, the PECVD carbon layer portion of the dual-layer media carbon overcoat 804 is on the MRL 804 layer and the sputtered CN layer portion of the dual-layer media carbon overcoat 804 is on the PECVD carbon layer. In other aspects, the CN layer portion of the dual-layer media carbon overcoat 804 is on the MRL 802 and the PECVD carbon layer portion of the dual-layer media carbon overcoat 804 is on the CN layer. In some examples, the MRL 810 may include one or more magnetic recording layers, which are not explicitly shown in in FIG. 8. Additional layers of the HAMR media may be provided, as discussed above, such as a heat sink layer, a capping layer, and a lubricant layer.

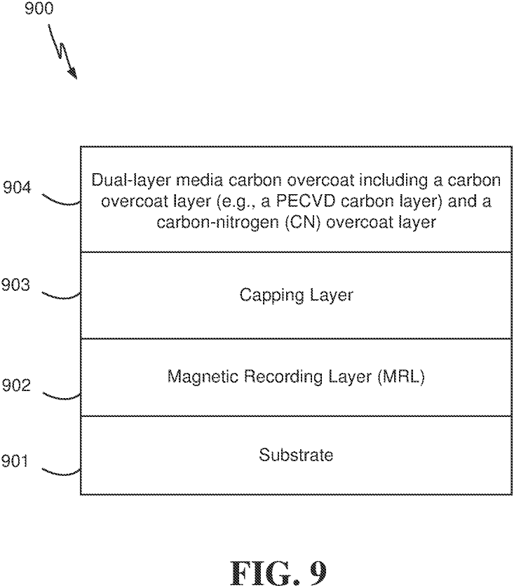

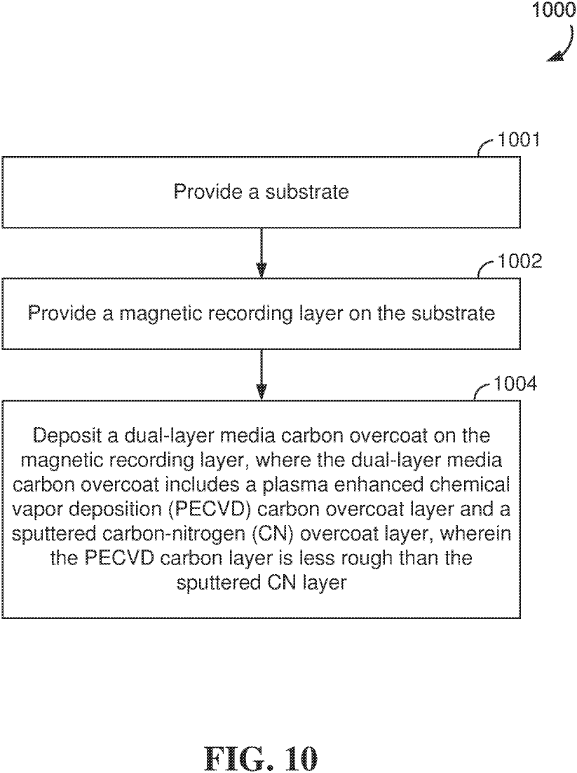

FIG. 9 is a side schematic view of an exemplary HAMR medium 900 in accordance with another aspect of the disclosure. The HAMR medium 900 has a stacked structure with a substrate 901, an MRL 902 on the substrate 901, a capping layer 903 on the MRL 902, and a dual-layer media carbon overcoat 904 on the capping layer 903, where the dual-layer media carbon overcoat 904 includes a carbon overcoat layer (e.g., a PECVD carbon layer) and a CN overcoat layer (e.g., a sputtered CN layer), and wherein the carbon layer is less rough (at least on the average) than the CN layer. In some aspects, the carbon overcoat layer portion layer (e.g., a PECVD carbon layer) of the dual-layer media carbon overcoat 904 is on the capping layer 903 and the CN layer portion of the dual-layer media carbon overcoat 904 is on carbon overcoat layer portion layer (e.g., a PECVD carbon layer) of the dual-layer media carbon overcoat 904. In other aspects, the CN layer portion of the dual-layer media carbon overcoat 904 is on the capping layer 903 and the carbon layer portion (e.g., a PECVD carbon layer) of the dual-layer media carbon overcoat 904 is on the CN layer of the of the dual-layer media carbon overcoat 904. In some examples, the MRL 910 may include one or more magnetic recording layers, which are not explicitly shown in FIG. 9. Additional layers of the HAMR media may be provided, as discussed above, such as a heat sink layer, a capping layer, and a lubricant layer.

FIG. 10 is a flowchart of a process 1000 for fabricating a HAMR medium in accordance with some aspects of the disclosure. In one aspect, the process 1000 can be used to fabricate the HAMR media described above in relation to FIG. 8. In block 1001, the process provides a substrate. In block 1002, the process provides an MRL on the substrate, e.g., by depositing the MRL. In block 1004, the process deposits a dual-layer media carbon overcoat on the MRL, where the dual-layer media carbon overcoat includes a PECVD carbon overcoat layer and a sputtered CN overcoat layer, wherein the PECVD carbon layer is less rough (at least on the average) than the sputtered CN layer. In some aspects, the PECVD carbon layer portion of the dual-layer media carbon overcoat is deposited on the MRL layer and the CN layer portion of the dual-layer media carbon overcoat is deposited on the PECVD carbon layer. In other aspects, the CN layer portion of the dual-layer media carbon overcoat is deposited on the MRL and the PECVD carbon layer portion of the dual-layer media carbon overcoat is deposited on the CN layer. In some examples, the MRL may be provided to include one or more magnetic recording layers, which are not explicitly shown in FIG. 10. Additional layers of the HAMR media may be provided, as discussed above, such as a heat sink layer, a capping layer, and a lubricant layer.

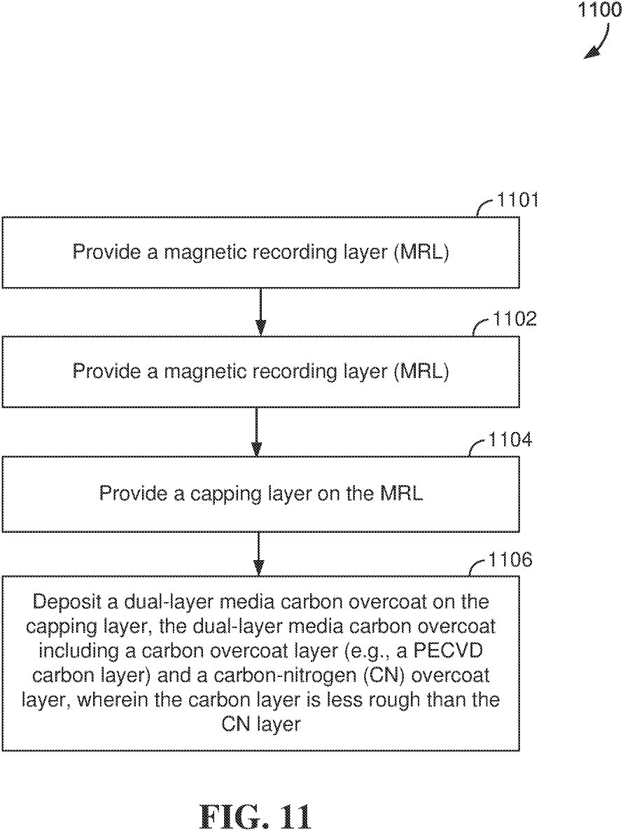

FIG. 11 is a flowchart of a process 1100 for fabricating a HAMR medium in accordance with some aspects of the disclosure. In one aspect, the process 1100 can be used to fabricate the HAMR media described above in relation to FIG. 9. In block 1101, the process provides a substrate. In block 1102, the process provides an MRL on the substrate, e.g., by depositing the MRL on the substrate. In block 1104, the process provides a capping layer on the MRL, e.g., by depositing the capping layer on the MRL. In block 1106, the process deposits a dual-layer media carbon overcoat on the capping layer, where the dual-layer media carbon overcoat includes a carbon overcoat layer (e.g., a PECVD carbon layer) and a CN overcoat layer (e.g., a sputtered CN layer), wherein the carbon layer is less rough (at least on the average) than the CN layer. In some aspects, the carbon overcoat layer portion layer (e.g., a PECVD carbon layer) of the dual-layer media carbon overcoat is deposited on the capping layer and the CN layer portion of the dual-layer media carbon overcoat is deposited on carbon overcoat layer portion layer (e.g., a PECVD carbon layer) of the dual-layer media carbon overcoat. In other aspects, the CN layer portion of the dual-layer media carbon overcoat is deposited on the capping layer and the carbon layer portion (e.g., a PECVD carbon layer) of the dual-layer media carbon overcoat is deposited on the CN layer of the of the dual-layer media carbon overcoat. In some examples, the MRL 910 may include one or more magnetic recording layers, which are not explicitly shown in in FIG. 9. Additional layers of the HAMR media may be provided, as discussed above, such as a heat sink layer, a capping layer, and a lubricant layer.

### Additional Aspects

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and subcombinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to be limiting of the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising.” “includes” “including.” “having.” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a. or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A magnetic recording medium, comprising:
a substrate;
a magnetic recording layer on the substrate;
a capping layer on the magnetic recording layer; and
a dual-layer media carbon overcoat on the capping layer, the dual-layer media carbon overcoat comprising a carbon layer and a carbon-nitrogen (CN) layer, wherein the carbon layer is less rough than the CN layer.

2. The medium of claim 1, wherein the carbon layer is on the capping layer and the CN layer is on the carbon layer.

3. The medium of claim 1, wherein the CN layer is on the capping layer and the carbon layer is on the CN layer.

4. The medium of claim 1, wherein the carbon layer comprises a plasma enhanced chemical vapor deposition (PECVD) carbon layer.

5. The medium of claim 1, wherein the CN layer comprises a sputtered CN layer.

6. The medium of claim 1, wherein a thickness of the CN layer is between 3 Angstrom (Å) and 30 Å, inclusive.

7. The medium of claim 1, wherein a thickness of the carbon layer is between 10 Angstrom (Å) and 40 Å, inclusive.

8. The medium of claim 1, wherein the capping layer comprises CoFe.

9. The medium of claim 1, further comprising a heat sink layer on the substrate, wherein the magnetic recording layer is on the heat sink layer.

10. A data storage device comprising:
a slider comprising a magnetic head; and
the medium of claim 1,
wherein the slider is configured to write information to the magnetic recording layer of the medium.

11. A method for manufacturing a heat-assisted magnetic recording (HAMR) medium, the method comprising:
providing a substrate;
providing a magnetic recording layer on the substrate; and
depositing a dual-layer media carbon overcoat on the magnetic recording layer, the dual-layer media carbon overcoat comprising a plasma enhanced chemical vapor deposition (PECVD) carbon layer and a sputtered carbon-nitrogen (CN) layer, wherein the PECVD carbon layer is less rough than the sputtered CN layer.

12. The method of claim 11, wherein the PECVD carbon layer is provided on the magnetic recording layer and the CN layer is provided on the PECVD carbon layer.

13. The method of claim 11, wherein the CN layer is provided on the magnetic recording layer and the PECVD carbon layer is provided on the CN layer.

14. The method of claim 11, wherein the CN layer is provided to a thickness between 3 Angstrom (Å) and 30 Å, inclusive.

15. The method of claim 11, wherein the PECVD layer is provided to a thickness between 10 Angstrom (Å) and 40 Å, inclusive.

16. The method of claim 11, further comprising forming a lubricant layer on the dual-layer media carbon overcoat.

17. The medium of claim 11, further comprising providing a capping layer between the magnetic recording layer and the dual-layer.

18. The medium of claim 11, wherein the capping layer is formed of CoFe.

19. The medium of claim 11, further comprising providing a heat sink layer on the substrate, wherein the magnetic recording layer is on the heat sink layer.

20. A medium configured for heat-assisted magnetic recording (HAMR), the HAMR medium comprising:
a substrate;
a magnetic recording layer on the substrate; and
a dual-layer media carbon overcoat on the magnetic recording layer, the dual-layer comprising a plasma enhanced chemical vapor deposition (PECVD) carbon layer and a sputtered carbon-nitrogen (CN) layer, wherein the PECVD carbon layer is less rough than the sputtered CN layer.
